(19) United States
(12) Patent Application Publication
(10) Pub. No.: US 2005/0246198 A1
(43) Pub. Date: Nov. 3, 2005

(54) Method for increasing efficacy and reducing cost of providing post-acute-care medical treatment to hospitalized aliens

(76) Inventor: Hector A. Oyarzabal, San Antonio, TX (US)

Correspondence Address: JACKSON WALKER L.L.P.;Suite 2100, 112 E. Pecan Street, San Antonio, TX, 78205, US

(21) Appl. No.: 10/834,738

(22) Filed: Apr. 29, 2004

(51) Int. Cl. G06F 17/60

(52) U.S. Cl. 705/2

(57) ABSTRACT

A method for reducing a local hospital's complications and cost of providing extended medical treatment to hospitalized aliens. Under current regulations, indigent aliens needing expensive long-term medical care are often treated in a local hospital for the duration of that care because the alien cannot be lawfully discharged. The alien is trapped in a hospital distant from the alien's home and the hospital loses money. The invention solves these problems by the hospital paying an agency medically qualified to accept the alien, arranging for a lawful plan of treatment in the alien's home country, the hospital lawfully discharging the alien into the agency's care, transporting and discharging the alien to a foreign health care provider's care. The local hospital pays all costs but realizes savings over its cost of providing the care itself in the host country.

### BACKGROUND OF THE INVENTION

1. Field of the Invention

Applicant's invention relates to the provision of post-acute hospital medical care to hospitalized aliens in a foreign health care system. More particularly, it relates to providing to appropriate hospitalized aliens the option of continuing medical care in an appropriate foreign country in a secure, humane, and orderly fashion, thus reducing the risk and expense of providing that care as compared to the host country.

2. Background Information

There are more than 8 million undocumented workers currently residing in the United States. The large transit of international visitors, executives, and workers between Mexico and the United States is also significant. According to the State of Texas, 2.8 to 3.0 million visitors come to Texas alone from Mexico every year. The economic impact on the health care system is significant. The greatest concentration of visitors and undocumented workers from Mexico is found in the states which have borders with Mexico. For example, in Texas alone there are more than 1 million undocumented workers.

U.S. health care systems currently expend more than 200 million unrecoverable dollars providing health-related services to undocumented workers. These costs are exacerbated due to the facts that undocumented workers tend not to be familiar with preventative techniques and rarely, if ever, carry medical or health insurance.

In addition, in the United States, trauma care constitutes the third costliest medical expense and costs the U.S. economy over $44 billion. Annually, of over 1 million undocumented workers, 25,000 may require trauma care.

Even after a U.S. hospital and host health care provider has resolved the acute phase of an alien's health care treatment, continuing treatment and other medical costs continue to expand daily and may become exorbitant. Long hospital stays, difficult disposition for continuation of post-acute-care, minimal charitable organizations, on-going utilization of equipment and supplies, personnel, services and inpatient complications all serve to increase the length of stay significantly longer than a U.S. citizen in the same medical condition with the same health care requirements and thus increase the burden on the U.S. hospital or in-patient acute-care institution.

In addition to financial costs are social costs. When an alien, documented or undocumented, requires prolonged in-patient acute-care hospitalization, the alien often feels isolated and alone due to being separated from his or her family, culture, and community; in a word, home. This situation is aggravated by the alien's inability to return to the workforce expeditiously. An active family support system, and its familiar cultural settings, are often vital to the recovery of a patient suffering from a catastrophic health condition.

### SUMMARY OF THE INVENTION

The present invention is a method for increasing efficacy and reducing the cost of providing post-acute-care hospitalization and continuation of medical treatment to hospitalized aliens. Alien, as the term is used within this application, means a foreign-born resident of or visitor to a host country who has not been naturalized and is still a subject or citizen of a foreign country. Hospitalized alien patients are identified for their suitability for relocation to an appropriate foreign country for the continuation of their medical care after their acute-care problem has been resolved in the admitting acute-care hospital facility. Suitability is indicated when the alien patient requires continuing medical care in a post-acute-care health care facility and the cost of providing that care in an appropriate foreign country is less than the cost of providing that care in the host country health care provider. Other factors utilized to determine suitability include the availability of the required health services in the appropriate foreign country and the willingness and desire of the alien to continue medical treatment in a foreign country.

Once a suitable alien patient is identified and the alien patient agrees to continue care in the appropriate foreign country, the alien patient is discharged into the care of a temporary service provider and ultimately transported to the appropriate foreign country for continuing medical care.

Cost savings are realized by the host country's health system because it only has to pay the lower cost associated with the provision of care in the appropriate foreign country as opposed to the higher cost associated with provision of care in the host country health care provider. The alien hospitalized patient realizes the benefit of being closer to family and friends during the patient's recuperation period.

Accordingly, it is a principal object of the invention to provide a method of reducing the financial burden of alien patients to a host country health care provider, after the alien patient's acute medical phase has been resolved in an acute-care medical facility, by transporting a suitable hospitalized alien patient to an appropriate foreign country for the continuation of medical care in a lower cost environment.

It is a further object of the invention to improve the continuity of post-acute care provided to an alien patient after the acute-care hospitalization and to provide that care in a culturally sensitive setting, thereby improving patient recovery and decreasing inpatient complications.

### BRIEF DESCRIPTION OF THE DRAWINGS

In the drawings, like elements are depicted by like reference numerals. The drawings are briefly described as follows:

FIG. 1 is a flow diagram representing the global process of transferring post-acute-care hospital medical treatment to a hospitalized alien patient from a host country health care provider to an appropriate foreign country.

FIG. 2 is a flow diagram representing the preferred embodiment for the method of identifying suitable alien patients, arranging for care in an appropriate foreign country, and effecting the transport of the alien patient to the appropriate foreign country.

FIG. 3 is a flow diagram representing the preferred embodiment for determining the level of care required by the hospitalized alien patient in the appropriate foreign country.

### DETAILED DESCRIPTION OF THE PREFERRED EMBODIMENT

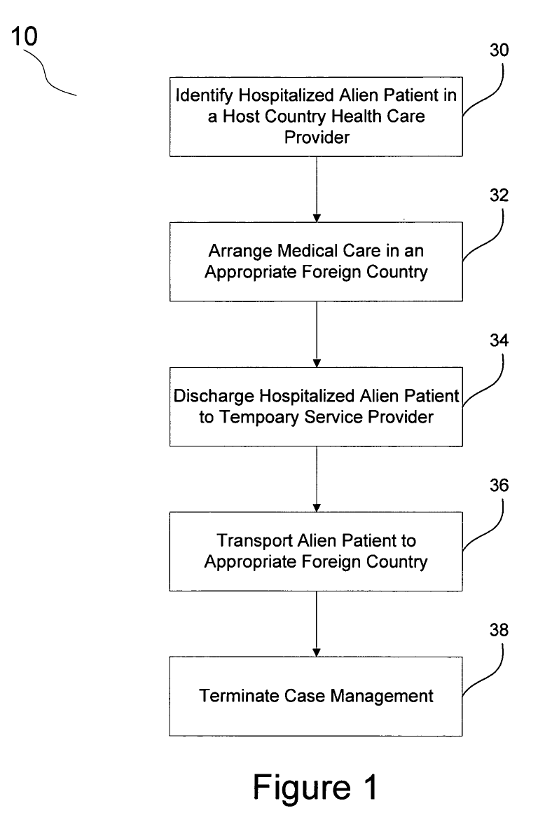

Referring to the figures, FIG. 1 depicts a preferred embodiment of a method of the present invention for increasing efficacy and reducing the cost of providing medical treatment to post-acute-care hospitalized alien patients (10). As used in Applicant's invention, the acute phase of a HAP's condition encompasses the severe symptoms of an illness, disorder, or traumatic event that presents a serious threat to the HAP's life or health, and which needs to be medically resolved and stabilized in an expeditious manner. The HAP enter the post-acute-care phase once these severe symptoms are stabilized and no longer immediately threaten the HAP's life or health. A hospitalized alien patient (HAP) is a patient who is hospitalized in a host country health care facility, is not a citizen of the host country, and for whom acute phase of his medical problem has been resolved.

As depicted in FIG. 1, the first step (30) is the identification of a suitable HAP in a host country health care provider system. In the preferred embodiment, a host country health care provider is envisioned as a hospital. However, a host country health care provider, as used in Applicant's invention, may encompass a sole-practitioner, HMO, PPO or any other individual, entity, or group which is authorized to provide medical care to patients and which would benefit from the advantages offered by Applicant's invention. As is discussed in greater detail below, suitability of a HAP for relocation depends upon the condition of the HAP after the acute phase of his or her medical treatment has been resolved, the willingness of the HAP or family member to receive appropriate post-acute-care services in a foreign country instead of in the host country health care provider, and the financial savings that may be realized by the host country health care provider system after effecting the relocation.

Once a suitable HAP is identified, a Temporary Service Provider (TSP) arranges relocation of the HAP from the host country health care provider and continuing post-acute medical care of the HAP in an appropriate foreign country (32). The factors that make a foreign country appropriate for the provision of continuing medical care are determined by the TSP but may include post-acute-care services needed after the acute-care hospitalization, consideration of the home country health care system of the HAP, general financial considerations of both health care systems, a special relationship between the foreign country and the TSP, and the ability of the TSP to derive a profit while simultaneously providing compassionate, organized, and quality transitional care to a HAP.

Once a suitable HAP is identified and medical care is arranged in an appropriate foreign country, the HAP is discharged to the TSP (34). The Temporary Service Provider is an entity which is medically licensed, and legally capable, under applicable law, of accepting discharged patients from the host country health care provider. Applicable law, as the term is used herein, refers to any law or code which affects the rights, duties, or obligations of the TSP. TSPs act as intermediaries between the host country health care provider and the health care provider of the foreign country.

After continuing medical care is arranged for the HAP by the TSP and the international health care plan and case-management is produced and agreed to, the HAP is transported to the foreign health care system (36). Once conveyance of the HAP's case to the foreign health care provider is completed, all case management by the TSP is terminated (38).

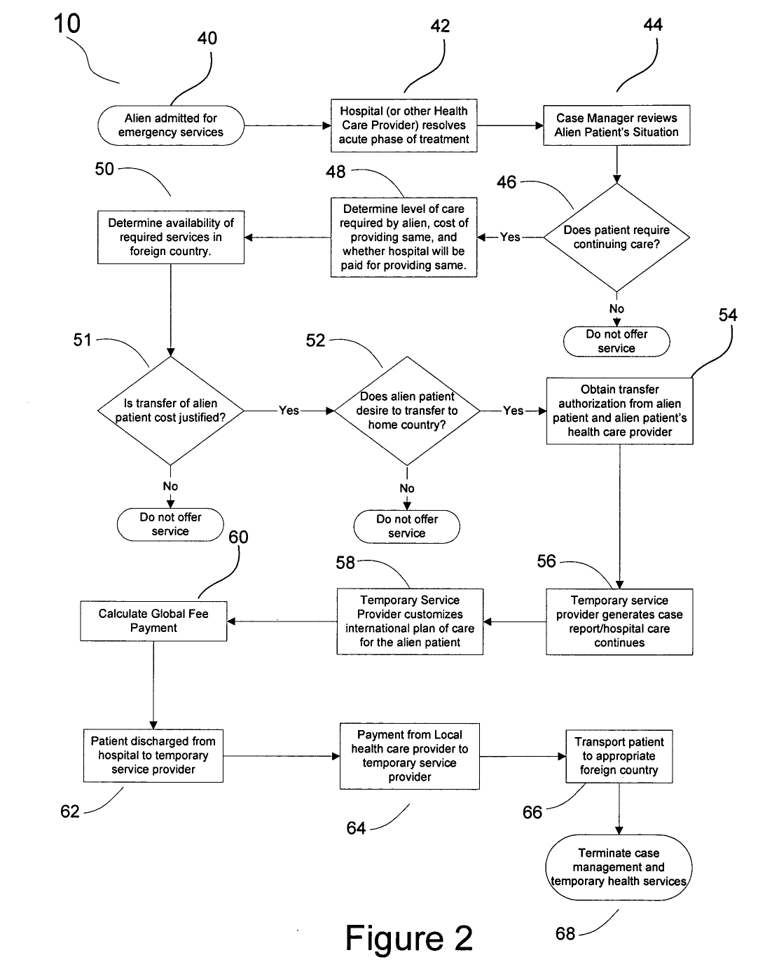

Referring to FIG. 2 which provides a detailed flow diagram of the Applicant's invention, it will be seen that an alien person is admitted to a medical facility for emergency medical services (40). The host country health care provider resolves the acute phase of the HAP's treatment (42). A case manager then reviews the HAP's case for suitability for continuation of medical care in and relocation to an appropriate foreign country (44).

A first question to be answered in reviewing a case for suitability is whether the HAP will require continuing medical care because of a post-acute-care chronic medical condition after discharge from the host country health care provider (46). If the HAP does not require continuing medical care after discharge from the admitting acute-care facility, the patient is not a candidate for TSP services.

If the HAP will require continuing medical care after discharge from the admitting acute-care facility, the HAP may be a candidate for TSP services. The case manager of the facility contacts a TSP for an initial evaluation. The TSP determines if the HAP qualifies for continuing post-acute-care services in a foreign health care system. If the patient is amenable to an international plan of care and case management, the TSP determines what level of continuing care is required by the patient (48). In the preferred embodiment of the invention, a HAP may be categorized as requiring one of three levels of care. The first level of care (70) is of minor complexity and requires a medical/surgical bed and ambulance transportation offering basic cardiac life support. The second level of care (74) is of medium complexity and requires a telemetry monitor bed and ambulance transportation offering advanced cardiac life support. The third level of care (78) is of major complexity and requires an intensive care unit bed and ambulance transportation offering advanced cardiac life support and artificial ventilation.

In particular, a first level of post-acute-care services is indicated by (a) the HAP's medical condition and clinical picture being of minor complexity for medical care services, (b) the HAP's receiving care in a medical/surgical bed for his medical condition, (c) the HAP's current medical condition, after the acute phase, requires continuing medical care for a period of time subsequent to discharge from the admitting health care facility, and (d) the transportation of the HAP, after discharge, requires only a standard ambulance and supervision with basic cardiac life support.

A second level of post-acute-care services is indicated by (a) the HAP's medical condition and clinical picture being of medium complexity for medical care services, (b) the HAP's receiving care in a telemetry bed for his medical condition, (c) the HAP's current medical condition, after the acute phase, requires continuing medical care for a period of time subsequent to discharge from the admitting health care facility, and (d) the transportation of the HAP, after discharge, requires only a standard ambulance and supervision with advanced cardiac life support.

A third level of post-acute-care services is indicated by (a) the HAP's medical condition and clinical picture being of major complexity for medical care services, (b) the HAP's receiving care in an intensive care unit (ICU) bed for his medical condition, (c) the HAP's current medical condition, after the acute phase, requires continuing medical care for a period of time subsequent to discharge from the admitting health care facility, and (d) the transportation of the HAP, after discharge, requires only a standard ambulance and supervision with advanced cardiac life support and artificial ventilation.

If the HAP does not fall within one of the levels of care offered by the TSP, that HAP is not suitable for TSP services.

If the HAP is medically suitable for TSP services, the HAP has been informed of and accepted TSP services and the international plan of care and case management, and the host health care provider approves the TSP's international plan of care and case management recommendations for relocation, post-acute-care services, case management, and conveyance to the foreign health care system providers in the appropriate setting of the foreign health care system, then the TSP consults with health care providers in an appropriate foreign country to determine whether the medical services required by the HAP are available (50). If the foreign country is capable of providing the required continuing medical care with post-acute-care services to the HAP, the TSP then determines if it is cost-effective to transport the HAP to the foreign country for continuing medical care services (51). If the host country health care provider will not realize at least a 5% savings, but preferably at least a 10% savings, off the cost of treating the HAP itself, the transfer is deemed to be not cost-effective.

If the appropriate foreign country is capable of providing continuing post-acute medical care to the HAP and it is cost-effective to do so, the HAP is offered the choice to continue his medical care in the appropriate foreign country after discharge from the admitting acute-care facility (52).

Authorization for acceptance of the TSP services is then obtained from the HAP and the host country health care provider (54). Authorization by the TSP is achieved in two parts. First, the HAP or one authorized to act on his behalf assents to the relocation by signing a release of responsibility form. The release of responsibility form may be written solely in the native language of the host country health care provider, solely in the native language of the HAP, or may be poly-lingual. By signing the release of responsibility form, the HAP acknowledges that he or she has been informed of the benefits and risks of accepting TSP services in, and transportation to, a foreign country, that he or she has authorized his discharge from the host health care facility, and that he or she generally releases all involved parties from liability for any adverse results that may occur. Second, the host country health care provider affirmatively accepts and approves the TSP's international plan of care and case management and agrees to pay a one-time fee intended to cover all the costs of the HAP related to the TSP's international plan of care and case in an appropriate foreign health care system.

While the host country health care provider continues to provide post-acute medical care to the hospitalized alien patient, the TSP generates a case report to inform the host health care facility of the level of care required by the HAP and the costs which will be incurred in providing that care (56). The case report is composed generally of the name and address of the admitting acute-care facility and the total cost of services to be provided by the TSP international plan of care and case management. This report accounts for the costs of all the temporary services provided by the TSP, the costs of the international care plan after discharge from the admitting host country health care provider, during transition of care from the admitting host country health care provider, and through the implementation of the international plan of care and case management by conveyance of the HAP to the foreign health care system. The cost for a given level of care is preferably quoted in the currency of the host country. The case report is essentially a forward-looking bill of services to the host care provider. It informs the host care provider of the expense of the TSP services to the HAP after discharge from the hospital for post-acute-care services, the relocation of the HAP to the foreign health care system, implementation of the international plan of care and case management, and conveyance of post-acute-care services to the foreign health care providers.

The TSP customizes the international plan of care and case management to ensure that the HAP's needs are met after discharge from the acute-care hospital, during transportation and transition of medical care, and until conveyance of the HAP to the foreign health care provider (58). The international plan of care includes, but is not limited to, international medical consultations and case management, patient and required staff transportation, foreign specialists and foreign medical teams, foreign tests and procedures, transitional medications, out-patient services, relocation expenses, and other medical care and non-medical expenses; all to the extent that the TSP states is needed for a legal and medically safe transferal.

The TSP then calculates a one-time global service fee payment to be paid by the host country health care provider intended to cover all of the costs of providing care to the HAP in the appropriate foreign country. The global service fee payment covers all of the post-acute-care transitional medical services to be rendered to the HAP after discharge from the host country health care provider, during transition of care, during the implementation of the international health care plan with case management, and until the final conveyance to the foreign health care provider, in the appropriate setting in the foreign health care system (60). The global service fee is based upon the cost of providing the alien patient with similar post-acute-care services as the health care of the host country health care provider and adjusted by the health care costs in the appropriate foreign country, the complexity of the HAP's case, in-patient and out-patient requirements, transportation requirements, ancillary costs, international communication and office overhead and a discount adjustment factor. The resultant global service fee should be at least 5% lower, but preferably 10% lower, than the cost to provide the same post-acute-care in the host country while also providing a profit to the TSP.

In a typical scenario, the costs savings obtained by utilization of Applicant's invention may be illustrated in the following table:

| | Host Country | | |
|---|---|---|---|
| Level of Care | Average Cost | Global Service Fee | Savings Realized |
| Level I | $1500 | $1150 | $350 |
| Level II | $2000 | $1600 | $400 |
| Level III | $2500+ | $2050 | $450 |

Once all authorizations have been given and the plan of care is set, the HAP is discharged to the care of the TSP (62). In one embodiment of the Applicant's invention, the HAP is delivered to the care of the TSP by the host country health care provider. In another embodiment of the Applicant's invention, the TSP will retrieve the HAP from the host country health care provider. In yet another embodiment of the Applicant's invention, the TSP will arrange for the HAP to be transported directly from the host country health care provider to the appropriate foreign country.

The global fee is preferably paid to the TSP by the host country health care provider (64) or a third party prior to or upon discharge of the HAP from the host country health care provider system. Once the host country health care provider or other third party has paid the global fee and discharged the HAP, the host country health care provider's obligations and responsibilities for the HAP are terminated.

Upon transportation and relocation of the HAP to the appropriate foreign country, the transition to the international plan of care and case management is effected, and the final placement of the HAP in the foreign health care system (66), services provided by the TSP is terminated (68).

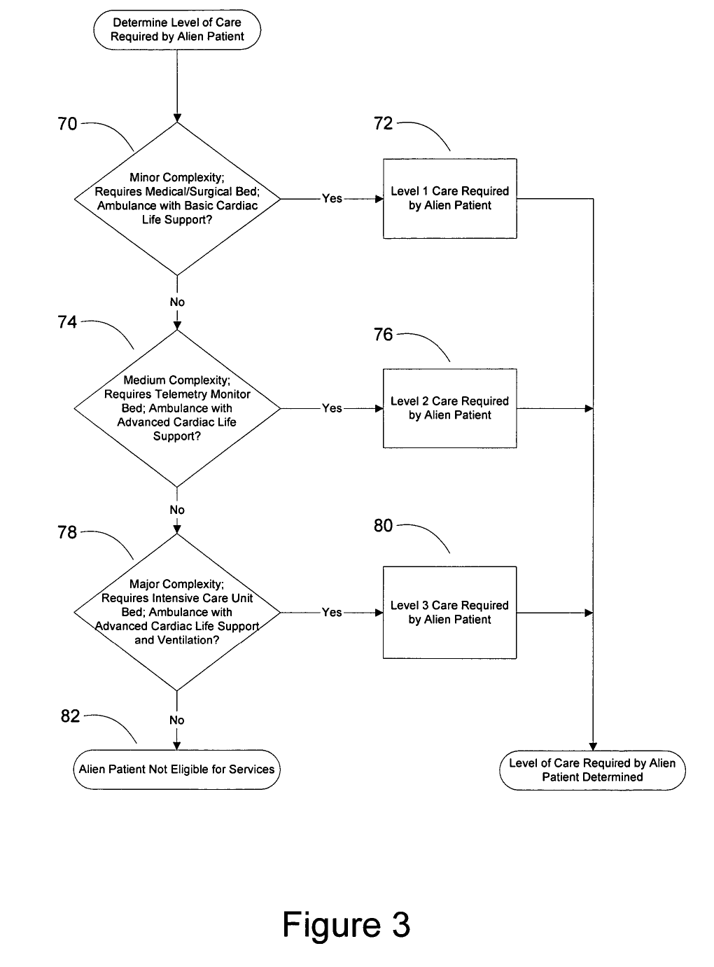

In FIG. 3 is depicted a detailed flow diagram for determining the level of care required by a HAP. If the HAP's care is of only minor complexity, requires only a medical/surgical bed, and requires ambulance transportation with only basic cardiac life support, (70), then Level 1 care is indicated for the HAP (72). If the HAP's care is of medium complexity requiring a telemetry monitor bed, and requires ambulance transportation with advanced cardiac life support, (74), then Level 2 care is indicated for the HAP (76). If the HAP's care is of major complexity requiring an intensive care unit bed, and requires ambulance transportation with advanced cardiac life support and ventilation, (78), then Level 3 care is indicated for the HAP (80). If none of those factors are met, then the HAP is not a suitable candidate for services (82).

In conclusion, a method is presented for increasing the efficacy and reducing the cost of providing continuing medical treatment to post-acute-care hospitalized alien patients, who require continuation of medical care because of their chronic medical condition, after discharge from an acute-care hospital. This new alternative of TSP's foreign health care services offers a compassionate, organized, and quality transition of care to a foreign health care system. The invention is illustrated by example in the drawing figures, and throughout the written description. Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A method for reducing the cost to a host country health care provider of providing post-acute-care medical treatment to an alien, comprising the steps of:
identifying a suitable hospitalized alien patient (HAP) in a host country health care provider;
creating a plan of care and case management for said HAP at a health care provider in an appropriate foreign country, said plan of care and case management being sufficient to permit said host country health care provider to lawfully discharge said HAP to a temporary service provider (TSP);
consulting with a health care provider in said appropriate foreign country to ensure availability of appropriate facilities and services to provide said post-acute-care medical treatment to said HAP;
arranging medical care at said health care provider in said appropriate foreign country which complies with said plan of care and case management for said HAP;
discharging said HAP to the care of said TSP, said TSP being legally capable under applicable law of accepting medical responsibility for said HAP and said TSP accepting medical responsibility for said HAP;
transporting said HAP to said foreign country;
said TSP charging a fee to said host country health care provider for said TSP's providing medical care to said HAP after said HAP is discharged from said host country health care provider, said fee set to ensure a determined fixed cost and at least a five percent savings to said host country health care provider, said fee set to provide a profit to said TSP;
said TSP lawfully discharging said HAP into the care of said health care provider in said appropriate foreign country and terminating said case management and health services provided by said TSP;
the method being capable of (1) lawfully discharging said HAP to the care of said TSP, (2) transporting said HAP to said HAP's chosen foreign country, (3) saving said health care provider at least five percent of said health care provider's anticipated cost of providing care to said HAP, (4) providing said host country health care provider with a determined, fixed cost for said HAP's post-acute care which is fixed prior to said host country health care provider discharging said HAP to said TSP, and (5) providing a profit to said TSP.

2. A method for reducing the cost to a host country health care provider of providing post-acute-care medical treatment to an alien, comprising the steps of:
identifying a suitable hospitalized alien patient (HAP) in a host country health care provider;
consulting with a health care provider in an appropriate foreign country to ensure availability of appropriate facilities and services to provide said post-acute-care medical treatment to said HAP;
creating a plan of care and case management for said HAP in said appropriate foreign country, said plan of care and case management being sufficient to permit said host country health care provider to lawfully discharge said HAP to a temporary service provider (TSP);
arranging medical care at said health care provider in said appropriate foreign country which complies with said plan of care and case management for said HAP;
discharging said HAP to the care of said TSP, said TSP being legally capable under applicable law of accepting medical responsibility for said HAP and said TSP accepting medical responsibility for said HAP;
transporting said HAP to said foreign country;
said TSP lawfully discharging said HAP into the care of said health care provider in said appropriate foreign country and terminating said case management and health services provided by said TSP;
the method being capable of (1) lawfully discharging said HAP to the care of said TSP, (2) transporting said HAP to said HAP's chosen foreign country, (3) saving said health care provider at least five percent of said health care provider's anticipated cost of providing care to said HAP, (4) providing said host country health care provider with a determined, fixed cost for said HAP's post-acute care which is fixed prior to said host country health care provider discharging said HAP to said TSP, and (5) providing a profit to said TSP.

3. The method of claim 2 wherein identification of a suitable alien patient comprises the steps of:
locating a HAP who will require continuing medical care after discharge from said host country health care provider;
determining the level of care required by said HAP after discharge from said host country health care provider;
consulting with said HAP and said HAP's doctor regarding said HAP's appropriateness for discharge and the desirability of relocating said HAP to an appropriate foreign country for continuing medical care;
offering said HAP the option of being discharged from said host country health care provider and obtaining continuing medical care in said appropriate foreign country; and
obtaining authorization for said relocation from said HAP and said HAP's doctor.

4. The method of claim 3 wherein obtaining authorization from said HAP comprises the step of said HAP signing a release form authorizing release from said host country health care provider and relocation to said appropriate foreign country for continuing medical care.

5. The method of claim 4 where said form is composed of writing in the native language of said host country health care provider and also in the native language of said HAP.

6. The method of claim 2 wherein discharging said HAP to the care of said TSP comprises the steps of:
said host country health care provider discharging said HAP into the medical care of said TSP and transporting said HAP to said TSP;
said TSP continuing treatment of said HAP until said patient is transported to said appropriate foreign country; and
transporting said HAP to said appropriate foreign country health care provider.

7. The method of claim 2 wherein discharging said HAP to the care of said TSP comprises the steps of:
said host country health care provider discharging said HAP into the medical care of said TSP;
said TSP retrieving said HAP from said host country health care provider;
said TSP continuing medical treatment of said HAP until said HAP is transported to said appropriate foreign country; and
transporting said HAP to said appropriate foreign country health care provider.

8. The method of claim 2 wherein discharging said HAP to the care of said TSP comprises the steps of:
said host country health care provider discharging said HAP into the medical care of said TSP;
said TSP retrieving said HAP from said host country health care provider; and
transporting said HAP to said appropriate foreign country health care provider.

9. The method of claim 2 wherein said TSP charges a fee to said host country health care provider for said TSP's providing medical care to said HAP after said HAP is discharged from said host country health care provider, said fee set to ensure at least a ten percent savings to said host country health care provider, said fee set to provide a profit to said TSP.

10. The method of claim 9 wherein said fee is further determined by factors comprising:
the cost of providing said HAP with health care in said host country health care system;
inpatient requirements, including the need for a medical/surgical bed, a telemetry monitor bed, or an intensive care unit bed; and
transportation requirements, wherein HAP may require basic ambulance transportation, ambulance transportation offering advanced cardiac life support, or ambulance transportation offering advanced cardiac life support and artificial ventilation.

11. A method for reducing the cost to a host country health care provider of providing post-acute-care medical treatment to an alien, comprising the steps of:
identifying a suitable hospitalized alien patient (HAP) in a host country health care provider;
consulting with said HAP and said HAP's doctor regarding said HAP's appropriateness for discharge and the desirability of relocating said HAP to an appropriate foreign country for continuing medical care;
determining the level of care required by said HAP after discharge from said host country health care provider;
consulting with a health care provider in said appropriate foreign country to ensure availability of appropriate facilities and services to provide said post-acute-care medical treatment to said HAP;
offering said HAP the option of being discharged from said host country health care provider and obtaining continuing medical care from said health care provider in said appropriate foreign country;
obtaining authorization for said relocation from said HAP and said HAP's doctor;
creating a plan of care and case management at said health care provider for said HAP in said appropriate foreign country, said plan of care and case management being sufficient to permit said host country health care provider to lawfully discharge said HAP to a temporary service provider (TSP);
arranging medical care at said health care provider in said appropriate foreign country which complies with said plan of care and case management for said HAP;
discharging said HAP to the care of said TSP, said TSP being legally capable under applicable law of accepting medical responsibility for said HAP and said TSP accepting medical responsibility for said HAP;
transporting said HAP to said foreign country;
said TSP charging a fee to said host country health care provider for said TSP's providing medical care to said HAP after said HAP is discharged from said host country health care provider, said fee set to ensure a determined fixed cost and at least a five percent savings to said host country health care provider, said fee set to provide a profit to said TSP; and
said TSP lawfully discharging said HAP into the care of a health care provider said health care provider in said appropriate foreign country and terminating said case management and health services provided by said TSP;
the method being capable of (1) lawfully discharging said HAP to the care of said TSP, (2) transporting said HAP to said HAP's chosen foreign country, (3) saving said health care provider at least five percent of said health care provider's anticipated cost of providing care to said HAP, (4) providing said host country health care provider with a determined, fixed cost for said HAP's post-acute care which is fixed prior to said host country health care provider discharging said HAP to said TSP, (5) providing a profit to said TSP, (6) providing medical services to said HAP in HAP's native language and culture, and (7) providing said HAP with an expected medical outcome at least the equivalent to the expected medical outcome at said host country health care provider.
